(19) United States
(12) Patent Application Publication
(10) Pub. No.: US 2016/0249091 A1
(43) Pub. Date: Aug. 25, 2016

(54) METHOD AND AN ELECTRONIC DEVICE FOR PROVIDING A MEDIA STREAM

(71) Applicant: SPOTIFY AB, Stockholm (SE)

(72) Inventors: Miles Lennon, New York City, NY (US); Angeliki Chrysafidi, Brooklyn, NY (US); Sigfrido Chirinos, Brooklyn, NY (US)

(21) Appl. No.: 14/627,410

(22) Filed: Feb. 20, 2015

(51) Int. Cl. H04N 21/43; H04N 21/439; H04N 21/233; H04N 21/242; H04N 21/6587

(52) U.S. Cl. CPC H04N 21/4307; H04N 21/242; H04N 21/6587; H04N 21/233; H04N 21/439

(57) ABSTRACT

The present disclosure relates to streaming of media content. In one example embodiment, an electronic device may comprise a user interface, a processor and a memory. The memory may comprise computer program code, which, when run in the processor causes the electronic device to: receive a first request requesting a first media content to be complemented with a second media content, the second media content being associated with the first media content; in response to receiving the first request, send, to a second electronic device, a second request for the first media content complemented with the second media content. Furthermore, the computer program code causes the electronic device to: receive, from the second electronic device, a media stream comprising the first media content and the second media content; and play the first media content of the received media stream complemented with the second media content of the received media stream.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure generally relates to the providing of media content. In particular, the embodiments of the present invention relate to methods of operating an electronic device and corresponding electronic devices for playing of media content.

### BACKGROUND

As computer technology has improved, the digital media industry has evolved greatly in recent years. Users are able to use electronic devices such as mobile communication devices (e.g., cellular telephones, smart phones, tablet computers, etc.) to consume music, video and other forms of media content. For instance, users can listen to audio content (e.g., music) and/or watch video content (e.g., movies, television (TV) broadcasts, etc.) on a variety of electronic devices.

When listening to songs the listener may sometimes perceive that it is hard to hear, or understand, the text of the song. This could be the case, when the volume of the singer's voice is low compared to the instruments' volume in the recording, when listening is performed in a noisy environment, etc. In addition, some singers may have voices which are difficult to hear.

Traditionally, music and other audio media have been offered on tapes, records, CDs (Compact Discs), etc., and buyers have received the lyrics together with the audio media, e.g. printed on an inner envelope.

Today, music is sometimes delivered by various streaming services to the consumers who listen to the music on electronic devices. When the consumers do not visit any music shop, he/she will then not be able to get the lyrics of the song together with the song or album which comprises the song.

Thus, there is a need to improve the user experience when delivering songs and other media content, e.g. through streaming services.

### SUMMARY

It is a general object of the embodiments of the present invention to improve user experience when playing back streamed media, such as listening to a song (audio content) or watching a film (video content).

This general object has been addressed by the appended independent claims. Advantageous embodiments are defined in the appended dependent claims.

According to a first aspect, a method of operating a first electronic device for playback of streamed media at a user interface is provided. The method according to the first aspect comprises: receiving a first request requesting a first media content to be complemented with a second media content, the second media content being associated with the first media content; in response to receiving the first request, sending, to a second electronic device, a second request for the first media content complemented with the second media content. Furthermore, the method comprises: receiving, from the second electronic device, a media stream comprising the first media content and the second media content, and playing the first media content of the received media stream complemented with the second media content of the received media stream at the user interface.

Furthermore, receiving may comprise receiving the first media content and the associated second media content as a synchronized stream, or as a first media stream and a second media stream, wherein each of the first and second media streams comprises respective markers, and wherein playing the first media content and the second media content comprises synchronizing the received first media content and the received second media content according to the markers. Moreover, the first media stream may comprise audio content, such as a song, and the second media content may comprise a textual content, such as lyrics.

Furthermore, the method may comprise receiving a third request for control of playback, and controlling playing in accordance with the third request, e.g. fast-forwarding, rewind, jump, skip, next, search, etc.

According to a second aspect, a first electronic device, which is adapted to perform the method steps of the above described method, is also provided. The first electronic device comprises a user interface, a processor, and a memory storing computer program code, which, when run in the processor causes the first electronic device to perform actions of the above described method. Furthermore, the first electronic device may be implemented as a mobile phone, a tablet computer, a lap-top computer, etc.

According to a third aspect, a method of operating a second electronic device for providing a streamed media to a first electronic device is provided. The method comprises: receiving from the first electronic device, a request for a first media content complemented with a second media content associated with the first media content; in response to receiving the request, complementing the first media content with the second media content into a media stream; and sending the media stream to the first electronic device. The media stream can be received by the first electronic device, and be played in a synchronized manner to a user at a user interface of the first electronic device.

Furthermore, the second media content may be stored at a third electronic device, and the method may comprise obtaining the second media content from the third electronic device.

Moreover, the method may comprise complementing the first media content with the second media content synchronized in one stream, or providing markers to the respective first and second media contents, in order to enable the first electronic device to play the first media content in a synchronized manner with the second media contents.

According to a fourth aspect, a second electronic device, which is adapted to perform the method steps of the above described method, is also provided. The second electronic device comprises a processor, and a memory storing computer program code, which, when run in the processor causes the first electronic device to perform actions of the above described method. Furthermore, the second electronic device may be implemented as a suitable type of media server, etc.

### BRIEF DESCRIPTION OF THE DRAWINGS

These and other aspects, features and advantages will be apparent and elucidated from the following description of various embodiments, reference being made to the accompanying drawings, in which:

FIG. 1 illustrates a system for playback of audio content, in accordance with an embodiment;

FIGS. 2A and 3A illustrate an example of a user interface which supports playback of audio content in accordance with an embodiment;

FIGS. 2B and 3B illustrate details of a user interfaces which support playback of audio content in accordance with an embodiment;

FIGS. 4 and 5 illustrate examples of user interfaces which support playback of video content in accordance with an embodiment;

FIG. 6 illustrates a flowchart of a method according to another embodiment;

FIG. 7 illustrates a flowchart of a method according to another embodiment; and

FIG. 8 illustrates an example of a computer program product according to an embodiment.

### DETAILED DESCRIPTION

The present invention will now be described more fully hereinafter. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art. Like reference numbers refer to like elements or method steps throughout the description.

As described earlier, some existing solutions for delivery of streamed media content at a user interface of an electronic device may be inadequate. For example, existing solutions for playback of audio content may be perceived as limiting by some users, because it may be hard to hear what an artist, or singer, sings. In turn, this may be perceived as frustrating. Furthermore, this annoyance may be even more prevalent in situations where the user is present in a noisy environment.

It is therefore a general object of embodiments described herein to allow for an improved playback of media content.

To address this, in accordance with an embodiment, described herein are an electronic device (e.g., a tablet computer or a smart phone) as well as a method of operating the electronic device for playback of media content played at a user interface of the electronic device. The example embodiments below disclose methods and arrangements by which a user may be enabled to request an electronic device to complement a played media content with another associated media content, e.g. complementing a song with lyrics, or a film with sub-titles. In some of the embodiments, the user may request to complement, but also to stop complementing the first media content on his/her own volition.

Within this disclosure, the term “synchronized” will be used to denote that a first media content and an associated media content are synchronized in time, i.e. that a part of the first media content and the corresponding part of the associated second media content are presented simultaneously, or substantially simultaneously. For instance, when the first media content is a song and the second media content is the lyrics of that song, a user device displays a lyrics line simultaneously as the corresponding part of the lyrics line is played. In addition, the media contents may be sent synchronized in a combined media stream, where an audio content (the song) and an image or text content (the associated lyrics), such that the song part of a specific lyrics line, are sent and received simultaneously within the media stream.

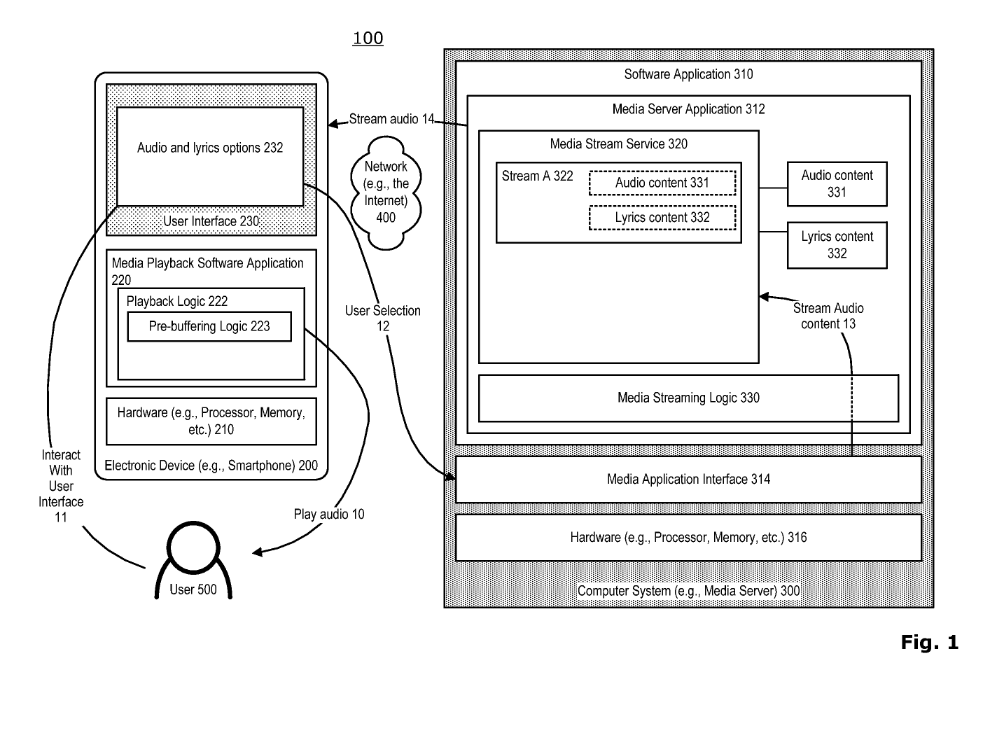

Turning now to the figures, various embodiments of the invention will be described in further detail. FIG. 1 illustrates a system 100 for playback of media content, in accordance with an example embodiment. The system 100 may comprise an electronic device 200 and a computer system 300 operating as a media server. The electronic device 200 may be communicatively connectable to the computer system 300 via a network 400, such as the Internet, as is conventional and known in the existing art. As can be seen in FIG. 1, only a single electronic device 200 and a single computer system 300 are shown. However, the computer system 300 may support the simultaneous use of multiple electronic devices, and/or the electronic device 200 can simultaneously access video content at multiple computer systems.

In the following description, the media content will be exemplified to be audio content so as not to obscure the description of the embodiments disclosed herein with unnecessary detail. This should, however, not be interpreted as limiting the scope of the various embodiments of the invention.

Turning now to the figures, various exemplifying embodiments of the invention will be described in further detail.

As shown in FIG. 1, the electronic device 200 may be used for the playback of audio content complemented with lyrics content, which is provided by the computer system 300. The electronic device 200 may be a mobile telephone, such as a smart phone. Alternatively, the electronic device 200 may be a tablet computer. In yet other embodiments, the electronic device 200 may be any other electronic device capable of playback of audio content complemented with lyrics content, such as, for example, one of the electronic devices of the following group: a computer, a laptop computer, and a mobile electronic device (e.g. a handheld entertainment device, a digital media player, or other media device).

The electronic device 200 may include one or several physical computer resources, or hardware resources 210. Likewise, the computer system 300 operating as a media server may include one or several physical computer resources, or hardware resources 316.

The computer system 300 may include an operating system or other processing system which supports execution of a software application 310, including a media server application 312 which may be used, for example, to stream audio content complemented with lyrics content. A media stream service 320 may be used to buffer audio content 331 and lyrics content 332, for streaming to one or more complemented audio streams 322. A media application interface 314 may receive requests from electronic devices 200 or other systems, to retrieve complemented audio content from the computer system 300.

Audio content or items 331 and lyrics content or items 332 may be provided, for example, within a database or repository, or may be received by the computer system 300 from another source (not shown). This another source (not shown) may be external to the computer system 300, i.e. it may be located remotely from the computer system 300.

A media streaming logic 330 may be used to retrieve or otherwise access the audio content 331 and lyrics content 332 in response to requests from electronic devices 200 or other systems, and populate the complemented stream service with streams 322 of corresponding audio content 331 and lyrics content 332 that may be returned to the requesting electronic device 200.

In some embodiments, the electronic device 200 comprises a user interface 230. Typically, the user interface 230 includes a display 232, which is adapted to display lyrics information and a speaker (not shown) which is adapted to play the audio content. The display 232 is preferably, though not necessarily, a touch-sensitive display that is adapted to detect or otherwise determine a user input.

Selecting lyrics to be displayed at the display 232 may be used, or otherwise interpreted, as a request or instruction to the media server application 312 to stream or otherwise return associated lyrics to an audio content which is being played. For example, in accordance with some embodiments, the software application 310 at the computer system 300 may be used to stream or otherwise communicate audio content complemented with associated lyrics to the electronic device 200, wherein the display 232 of said user interface 230 at the electronic device 200 is adapted to display the selected lyrics when playing the audio content at the speaker of the electronic device 200.

A user 500 may interact 11 with the user interface 230 and issue requests, for example the playing a selected song (audio content) and displaying the associated lyrics (lyrics content or information) on the electronic device 200. The user's selection that lyrics is requested may be communicated 12 to the media server application 312, via the media application interface 314. The media server application 312 may then be instructed 13 to stream corresponding audio content, including one or more streams of audio content data 331 and lyrics content data 332, and subsequently stream 14 or otherwise communicate to the user's electronic device 200. In accordance with some embodiments, pre-buffering requests from the electronic device 200 may also be communicated to the media server application 312 via the media application interface 314. At the electronic device 200, in response to the user's interaction with the user interface 230, the media playback application 220, including the playback logic 222, may display 10 the requested lyrics content and play the associated audio content to the user 500, for example by playing back a song on the electronic device 200, as described in further detail below.

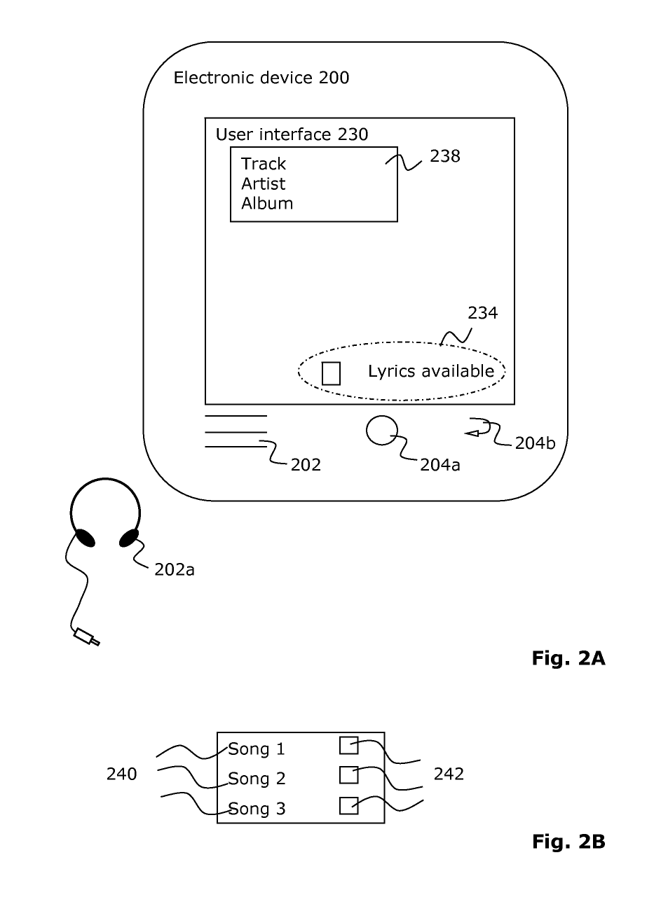

FIG. 2A illustrates a user interface 230 of an electronic device 200. The user interface 230 comprises a display at which song information 238 about the currently played song can be displayed. A song is a form of media content and more specifically an audio content. The electronic device 200 also comprises a speaker 202 at which the user interface 230 plays the song, and various user controls 204a, 204b by which the user controls playback of the song. In this embodiment the user controls are implemented as one physical button 204a and one virtual button 204b. In the figure, a headset 202a is illustrated which as an alternative may be connected and used instead of the speaker 202 to play the song.

On the display, a lyrics control 234 may be arranged which informs the user that lyrics of the song are available to be displayed while the song is being played. In this embodiment, the display is a touch screen and the lyrics control 234 is implemented as a pre-defined surface (dash-dotted in the figure) of the display. The user could request the lyrics by touching the box of the lyrics control 234, e.g. by a tapping gesture or a pressing gesture.

It is to be noted that the inventive concept is not limited to the above described implementation of the user interface 230. In some embodiments, the user interface 230 may comprise further information. For instance, a suitable image, such as an album cover of the played song may be displayed on the display while playing the song.

By arranging the lyrics control 234 at the user interface, the user will be enabled to request to complement the song with the associated lyrics. Thereby, the user will see what the artist sings at the moment, which increases the user experience of the playback.

FIG. 2B illustrates a detail of the user interface 230 of some above described embodiments. In this figure, the display presents titles 240 of a plurality of songs which are possible to play. Furthermore, the display comprises lyrics controls 242 beside the titles 240. This embodiment is related to the embodiment described above in conjunction with FIG. 2A. Possible songs (with or without selectable lyrics) may be presented in advance before playback of any of the songs. For instance, when the user selects one of the titles 240, he/she may also request the lyrics of the song by tapping or touching the corresponding lyrics control 242.

Thereby, the user is enabled to request the lyrics in advance, such that the lyrics will be displayed already from start of the song.

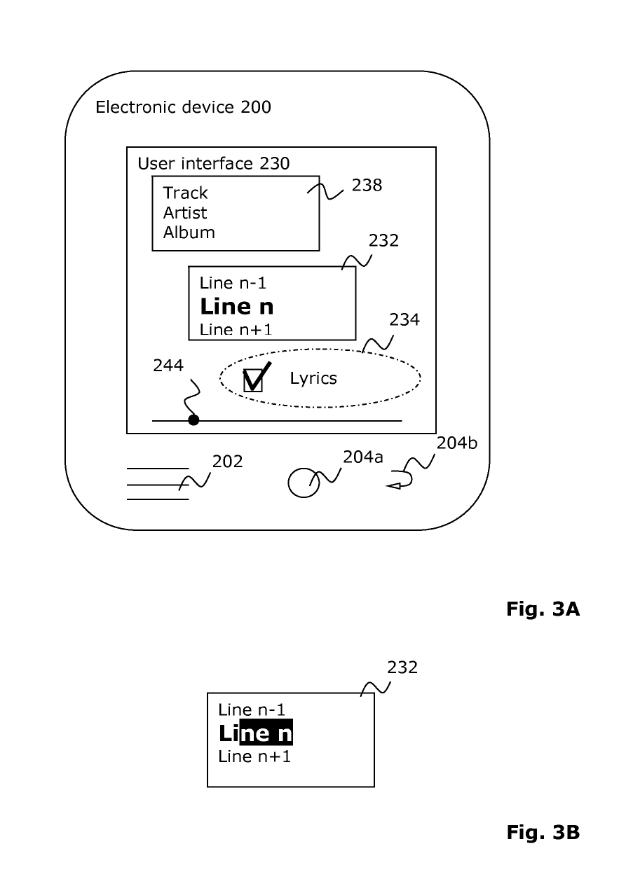

FIG. 3A illustrates an example of a visual appearance of the user interface 230 of the electronic device 200, when lyrics have been selected for a song which is being played, in accordance with one embodiment. This embodiment is related to the one described in conjunction with FIG. 2A, and the same reference numbers has therefore been applied when appropriate. As seen in FIG. 3A, lyrics information 232 associated with the song being played is displayed on the display of the user interface 230. In this embodiment the current lyrics line is marked as bold, and the previous and next lyrics lines are non-bold. However, this illustrated appearance is an example and may be different within the inventive concept, e.g. in accordance with selected user-settings. The lyrics control 234 is designed to inform the user that lyrics is selected. In this embodiment this is performed by a marked box and the text “Lyrics” as an example, without being limited thereto.

In some embodiments, the lyrics control 234 may be alternatively designed when lyrics is selected. For instance, the lyrics control 234 may be designed as commercial information, such as a text: “Lyrics presented by Company A”, etc.

Moreover, the lyrics information 232 may be displayed as long as the user wants. For instance, the lyrics information 232 may be removable, such that the user may request the electronic device 200 to stop displaying lyrics information. This request may be implemented in various ways, e.g. by unmarking the checkbox of the lyrics control 234, or by sweeping the lyrics control 234 or the lyrics information in a horizontal direction.

In some embodiments, the user interface 230 may be implemented to enable the user to control the playback of the song further. This further control may be implemented in a number of various ways. For instance, a user who wants to listen to a specific part of the song may request the electronic device to control the playback of the song, e.g. by affecting the playing of the audio content or the displaying of the associated lyrics information 232. The user interface 230 is adapted to enable the user to request this further control by scrolling the lyrics information upwards or downwards. Alternatively, a timing control 244 which is arranged on the user interface 230 during playback may be controlled by the user. For instance, the user may request fast-forwarding or rewinding of the song and the associated lyrics.

In some embodiments, the user interface 230 may be provided with functionality for searching for a specific part of the lyrics information 232, such as e.g. a specific line of the lyrics information 232. Typically, such search functionality may be implemented by arranging a search field at the display, where a user can input a text string to search for.

One alternative implementation example of displaying the lyrics information 232 is illustrated in FIG. 3B. As shown, the user interface 230 marks the current lyrics line of the associated song in more detail than in some other embodiments, In this example, the part of the current lyrics line for which the song already has been played is unmarked and the remaining part of the lyrics line is marked. This additional detail of the marking could increase the user experience further.

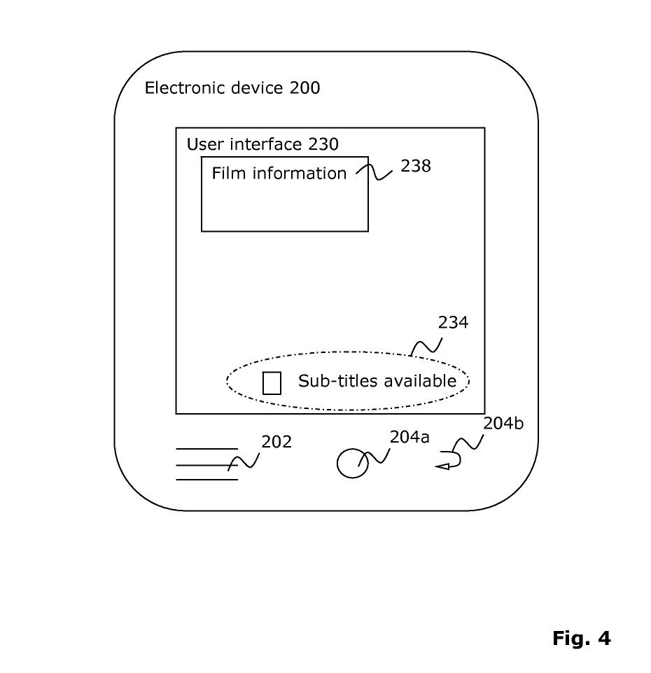

FIG. 4 illustrates a user interface 230 of an electronic device 200. The user interface 230 comprises a display on which film information 238 of a currently played film is displayed, e.g. film title, etc. A film is a form of media content and more specific a video content. The electronic device 200 comprises also a speaker 202 at which the user interface 230 plays the audio content of the film, and various user controls 204a, 204b by which the user controls the playback. In this embodiment the user controls are implemented as one physical button 204a and one virtual button 204b.

On the display, a sub-title control 234 is arranged which informs the user that sub-titles of the film is available to be displayed while the film is playing. In this embodiment, the display is a touch screen and the sub-title control 234 is implemented as a pre-defined surface of the display. The user requests sub-titles by touching the check-box of the lyrics control 234, e.g. by a tapping or a pressing.

It is to be noted that the inventive concept is not limited to the above described implementation of the user interface 230. In some embodiments, the user interface 230 may comprise further information.

By providing the sub-title control 234, the user will be enabled to request the user interface 230 to complement the film with the associated sub-titles. Thereby, the user will be enabled to see what the actors of the film say. Providing the sub-titles could be appreciated by the users, especially in noisy environments and by users having a hearing impairment.

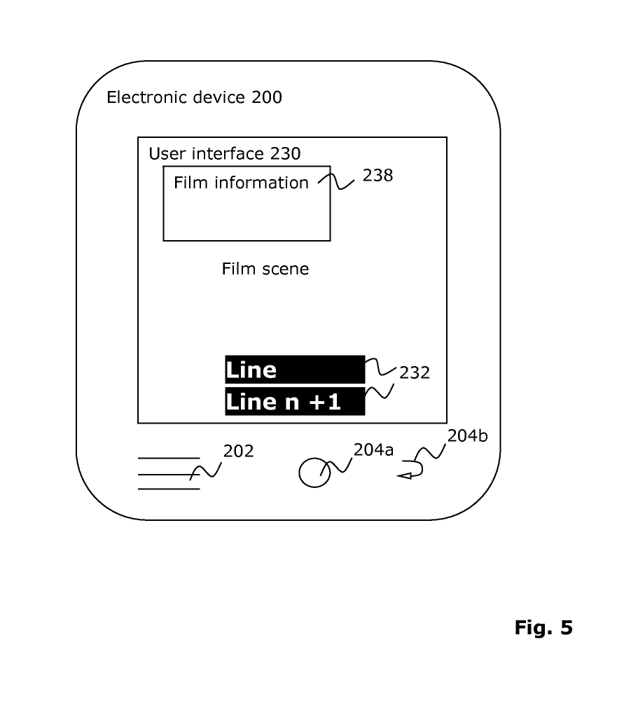

FIG. 5 illustrates an example of a visual appearance of the user interface 230 of the electronic device 200, when sub-titles 232 have been selected for a film which is currently played (illustrated as “Film scene” in the figure), in accordance with one embodiment. This embodiment is related to the embodiment described in conjunction with FIG. 4 and the same reference numbers have therefore been applied when appropriate. As seen in FIG. 5, sub-titles 232 associated with the currently played film are displayed on the display of the user interface 230. In this embodiment the sub-titles 232 are illustrated as white text on a black background, as a non-limiting example. However, in some embodiments the user may set the appearance of the sub-titles on his/her own volition, e.g. by formatting text style, text font, text background, etc.

Moreover, the sub-titles 232 may be displayed as long as the user wants. For instance, the sub-titles 232 may be removable, such that the user may request the electronic device 200 to stop displaying sub-titles. This request may be implemented in various ways, e.g. by sweeping the sub-titles 232 horizontal direction.

### EXAMPLE METHODS

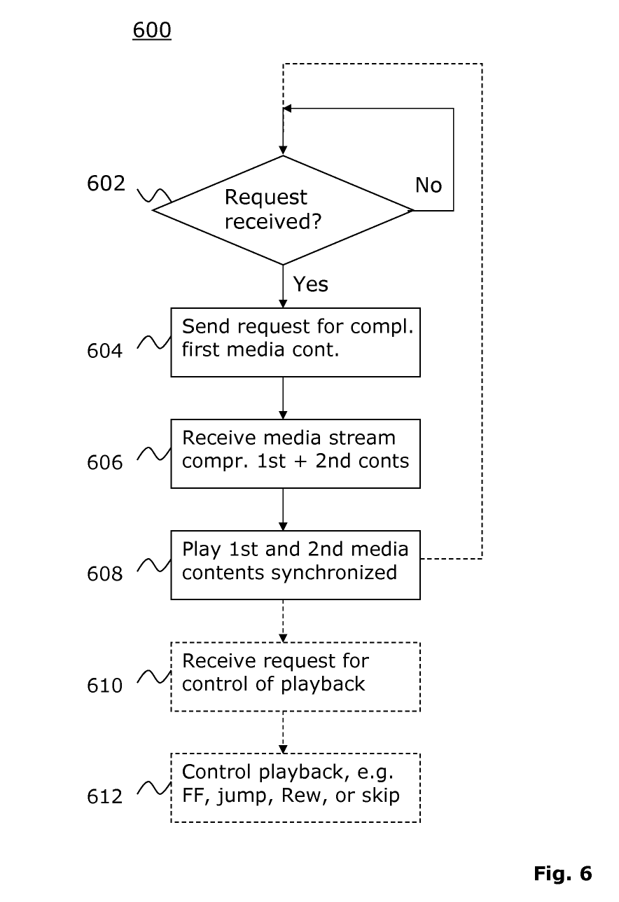

FIG. 6 illustrates an example method 600 of operating a first electronic device 200 for playback of media content according to embodiments herein. The method comprises receiving 602 a first request to play audio content complemented with associated textual content (e.g. a song complemented with lyrics as in the example of FIG. 3A) at the user interface 230 of the electronic device 200. In response to receiving the first request, a second request is sent 604 to a second electronic device (e.g. a media server) for the audio content complemented with the textual content.

A media stream is received 606 from the second electronic device according to the second request. The media stream comprises the requested audio content and textual content. The received audio content is played 608 synchronized with the received textual content at the user interface of the first electronic device.

In some embodiments, the audio content and the textual content are received 606 synchronized in a combined media stream from the second electronic device (e.g. a media server) and the first electronic device (e.g. a user device) plays the combined media stream by displaying the textual content at a speaker while playing the audio content at a display of the user interface. However, the inventive concept is not limited thereto and may be alternatively implemented. In some embodiments the audio content and textual content are instead received unsynchronized but are provided with respective time markers, which the first electronic device utilizes for synchronizing the audio and textual contents with respect to each other when playing 608 the audio content. For instance the textual content may be sent as a text file with time markers from the second electronic device when being requested. Furthermore, the audio content and the textual content may be sent in separate media streams or in a combined un-synchronized stream.

In some embodiments, the first electronic device continuously monitors 602 whether a first request is received, as indicated in the FIG. 6. The electronic device may in addition monitor whether the user still wants to display the textual content or if he/she wants to stop the displaying (dashed line from action 608 to action 602). In some embodiments the first electronic device may then request the second electronic device to stop sending the textual content, but in some other embodiments the first electronic device proceeds receiving the textual content without displaying it.

In some embodiments, the first electronic device may receive 610 a third input for control of the playback. For instance, the third input relates to any of: fast-forwarding, rewind, jump, skip, next, search, etc. For instance, when a user wants to jump to a specific part of a song, he/she may scroll the lyrics information until the wanted lyrics line is seen at the display and proceed to play the song there from. The first electronic device may then control 612 the playback in accordance with the received 610 request.

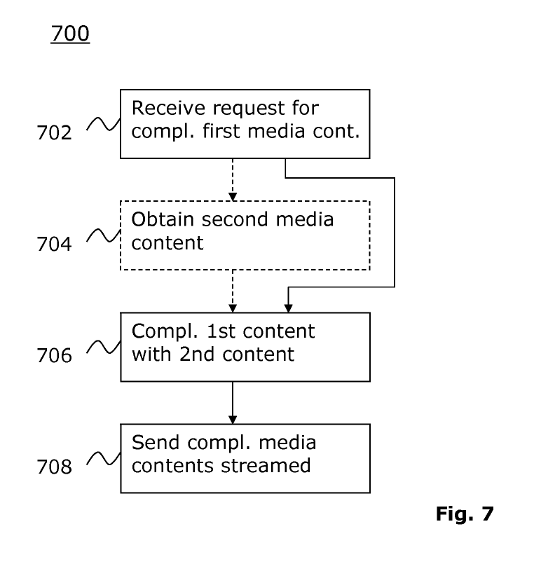

FIG. 7 illustrates an example method 700 of operating a second electronic device 300 (e.g. a media server) for providing streamed media to a first electronic device according to embodiments herein. The method comprises receiving 702 a request for an audio content complemented with associated textual content (e.g. a song complemented with lyrics as in the example of FIG. 3A). The request is received 702 from the first electronic device (e.g. a user device, such as a mobile phone, a tablet computer, etc.).

In response to the received 702 request, the second electronic device matches 706 the audio content with the textual content, into a media stream. The media stream is sent 708 to the first electronic device in order to be played synchronized at a user interface 230 of the electronic device 200.

In some embodiments, the lyrics information is stored at the second electronic device, and the second electronic device matches the audio content and the textual content into a combined media stream which is sent 708 to the first electronic device. One advantage is then that the first electronic device does not have to synchronize the audio content with the textual content when performing playback. Especially, this is beneficial when calculating capacity of user devices are limited.

In some embodiments, the textual content is stored at another electronic device remote from the second electronic device. For instance, when a service provider stores audio content and textual content on respective electronic devices, the second electronic device obtains 704 the textual content from the electronic device on which the textual content is stored, before matching 706 the audio content with the textual content.

In some embodiments, the audio content and textual content may be sent as different sub-streams of the media stream, or sent as separate media streams. In these embodiments the audio content and the textual content are provided with respective time markers, which the first electronic device will utilize when synchronizing the audio content and the textual content.

It is to be noted that even if the above described embodiments have been described for audio content which is complemented with textual content, the inventive concept is not limited thereto. A designer may apply the described concept also for other suitable types of media contents when appropriate. For instance, the designer may devise a method for complementing video content with associated textual content or image content, such as complementing a film with sub-titles or commercial information. In addition, the textual content of the above described embodiments may alternatively be implemented as images when appropriate. For instance, one or more lyrics lines may be sent as images.

### EXAMPLE COMPUTER-READABLE MEDIUMS

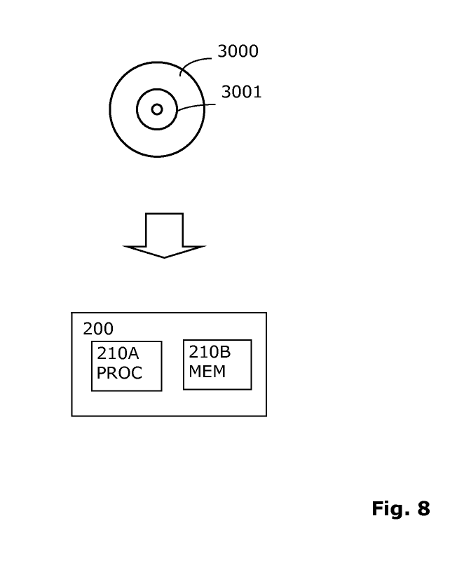

Turning now to FIG. 8, another embodiment will be briefly discussed. FIG. 8 shows an example of a computer-readable medium, in this example in the form of a data disc 3000. In one embodiment the data disc 3000 is a magnetic data storage disc. The data disc 3000 is configured to carry instructions 3001 that when loaded into a processor 210A of an electronic device 200 having a memory 210B, executes a method or procedure according to the embodiments disclosed in this disclosure. The data disc 3000 is arranged to be connected to or within and read by a reading device (not shown), for loading the instructions into the processor. One such example of a reading device in combination with one (or several) data disc(s) 3000 is a hard drive. It should be noted that the computer-readable medium can also be other mediums such as compact discs, digital video discs, flash memories or other memory technologies commonly used. In such an embodiment the data disc 3000 is one type of a tangible computer-readable medium. The instructions may alternatively be downloaded to a computer data reading device, such as a computer or other electronic device 200 capable of reading computer coded data on a computer-readable medium, by comprising the instructions in a computer-readable signal (not shown) which is transmitted via a wireless (or wired) interface (for example via the Internet) to the computer data reading device for loading the instructions into a processor 210A of the electronic device 200. In such an embodiment, the computer-readable signal is one type of a non-tangible computer-readable medium.

### SELECTED EXAMPLE EMBODIMENTS

The technology described in this disclosure thus encompasses without limitation the following numbered example embodiments:

### Embodiment 1

A method of operating a first electronic device for playback of streamed media at a user interface, the method comprising:

receiving a first request requesting a first media content to be complemented with a second media content, the second media content being associated with the first media content, in response to receiving the first request, sending, to a second electronic device, a second request for the first media content complemented with the second media content,

receiving, from the second electronic device, a media stream comprising the first media content and the second media content,

playing the first media content of the received media stream complemented with the second media content of the received media stream at the user interface.

### Embodiment 2

The method of embodiment 1, wherein the first media content is synchronized with the second media content.

### Embodiment 3

The method of embodiment 1, wherein receiving comprises: receiving the media stream as a first media stream and a second media stream separately, wherein each of the first and second media streams comprises respective markers, and wherein playing the first media content and the second media content comprises synchronizing the received first media content and the received second media content according to the markers.

### Embodiment 4

The method of any one of the embodiments 1 to 3, wherein the first media content comprises audio content and the second media content comprises textual content, and wherein playing the first media content and the second media content comprises playing the first media content at the user interface and displaying the second media content on the user interface.

### Embodiment 5

The method of embodiment 4, wherein the audio content comprises a song and the textual content comprises lyrics.

### Embodiment 6

The method of any one of the embodiments 1 to 3, wherein the first media content comprises audio content and the second media content comprises at least one of: image content and video content.

### Embodiment 7

The method of any one of the embodiments 1 to 3, wherein the first media content comprises video content and the second media content comprises textual content, and wherein playing the first media content and the second media content comprises displaying the first media content on the user interface and displaying the second media content on the user interface, such that the second media content at least partly overlaps the first media content.

### Embodiment 8

The method of any one of the embodiments 1 to 7, further comprising:

receiving a third request for control of playback, and

controlling playing in accordance with the received third request.

### Embodiment 9

The method of embodiment 8, wherein the third request for control of playback relates to at least one of: fast-forwarding, rewind, jump, skip, next, and search.

### Embodiment 10

A first electronic device for playback of a streamed media at a user interface, the first electronic device comprising:

a user interface;

a processor; and

a memory storing computer program code, which, when run in the processor causes the first electronic device to:

receive a first request requesting a first media content to be complemented with a second media content, the second media content being associated with the first media content,

in response to receiving the first request, send, to a second electronic device, a second request for the first media content complemented with the second media content,

receive, from the second electronic device, the media stream comprising the first media content and the second media content, and

play the first media content of the received media stream complemented with the second media content of the received media stream at the user interface.

### Embodiment 11

The first electronic device of embodiment 10, wherein the processor is adapted to receive the first media content synchronized with the second media content.

### Embodiment 12

The first electronic device of embodiment 10, wherein the processor is adapted to receive the media stream as a first media stream and a second media stream separately, wherein each of the first and the second media streams comprises respective markers, and further adapted to synchronize the received first media content and the second media content according to the markers when playing the first media content and the second media content.

### Embodiment 13

The first electronic device of any one of the embodiments 10 to 12, wherein the first media content comprises audio content and the second media content comprises textual content, and wherein the memory stores computer program code, which, when run in the processor causes the first electronic device to play the first media content and the second media content by playing the first media content at the user interface and displaying the second media content on the user interface.

### Embodiment 14

The first electronic device of embodiment 13, wherein the audio content comprises a song and the textual content is lyrics.

### Embodiment 15

The first electronic device of any one of the embodiment 10 to 12, wherein the first media content comprises audio content and the second media content comprises at least one of: image content and video content.

### Embodiment 16

The first electronic device of any one of the embodiments 10 to 12, wherein the first media content comprises video content and the second media content comprises textual content, and wherein the memory stores computer program code, which, when run in the processor causes the first electronic device to play the first media content and the second media content by displaying the first media content at the user interface and displaying the second media content on the user interface, such that the second media content at least partly overlaps the first media content.

### Embodiment 17

The first electronic device of any one of the embodiments 10 to 16, wherein the controller is adapted to receive a third request for control of playback, and further adapted to control playing in accordance with the received third request.

### Embodiment 18

The first electronic device of embodiment 17, wherein the third request relates to at least one of: fast-forwarding, rewind, jump, skip, next.

### Embodiment 19

A method of operating a second electronic device for providing a streamed media to a first electronic device, the method comprising:

receiving, from the first electronic device, a request for a first media content complemented with a second media content associated with the first media content,

in response to receiving the request, complementing the first media content with the second media content into a media stream, and

sending the media stream to the first electronic device,

such that the media stream can be received by the first electronic device, and be played in a synchronized manner to a user at a user interface of the first electronic device.

### Embodiment 20

The method of embodiment 19, wherein the first media content is stored at the second electronic device, and the method further comprises:

obtaining the second media content from a third electronic device.

### Embodiment 21

The method of embodiment 20, wherein obtaining comprises sending a request for the second media content and receiving the second media in response thereto.

### Embodiment 22

The method of any one of embodiments 19 to 21, wherein complementing comprises synchronizing the first media content and the second media content in the media stream.

### Embodiment 23

The method of any one of embodiments 19 to 21, wherein complementing comprises providing markers to the respective first media content and second media content.

### Embodiment 24

The method of any one of the embodiments 19 to 23, wherein the first media content comprises audio content and the second media content comprises textual content.

### Embodiment 25

The method of embodiment 24, wherein the audio content comprises a song and the text content comprises lyrics.

### Embodiment 26

The method of any one of the embodiments 19 to 23, wherein the first media content comprises audio content and the second media content comprises at least one of: image content and video content.

### Embodiment 27

The method of any one of the embodiments 19 to 23, wherein the first media content comprises video content and the second media content comprises text content.

### Embodiment 28

A second electronic device for providing streamed media to a first electronic device, the second electronic device comprising:

a processor; and a

memory storing computer program code, which, when run in the processor causes the second electronic device to:

receive, from the first electronic device, a request for a first media content complemented with a second media content associated with the first media content,

in response to receiving the request, complementing the second media content with the first media content into a media stream, and

send the media stream to the first electronic device,

the media stream to be received by the first electronic device, and to be played in a synchronized manner to a user at a user interface of the first electronic device.

### Embodiment 29

The second electronic device of embodiment 28, wherein the first media content is stored at the second electronic device, and the memory stores computer program code, which, when run in the processor causes the second electronic device to obtain the second media content from a third electronic device.

### Embodiment 30

The second electronic device of embodiment 29, wherein the memory stores computer program code, which, when run in the processor causes the second electronic device to obtain the second media content by sending a request for the second media content to the third electronic device and receiving the second media in response thereto.

### Embodiment 31

The second electronic device of embodiment 29, wherein the memory stores computer program code, which, when run in the processor causes the second electronic device to complement the first media content with the second media content by synchronizing the first media content and the second media content in the media stream.

### Embodiment 32

The second electronic device of embodiment 29, wherein the memory stores computer program code, which, when run in the processor causes the second electronic device to complement the first media content with the second media content by providing markers to the respective first media content and second media content, before sending the first media content and the second media content as the media stream.

### Embodiment 33

The second electronic device of any one of the embodiments 28 to 32, wherein the first media content comprises audio content and the second media content comprises textual content.

### Embodiment 34

The second electronic device of embodiment 33, wherein the audio content comprises a song and the textual content comprises lyrics.

### Embodiment 35

The second electronic device of any one of the embodiments 28 to 34, wherein the first media content comprises audio content and the second media content comprises at least one of: image content and video content.

### Embodiment 36

The second electronic device of any one of the embodiments 28 to 35, wherein the first media content comprises video content and the second media content comprises text content.

In the detailed description hereinabove, for purposes of explanation and not limitation, specific details are set forth in order to provide a thorough understanding of various embodiments described in this disclosure. In some instances, detailed descriptions of well-known devices, components, circuits, and methods have been omitted so as not to obscure the description of the embodiments disclosed herein with unnecessary detail. All statements herein reciting principles, aspects, and embodiments disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Thus, for example, it will be appreciated that block diagrams herein can represent conceptual views of illustrative circuitry or other functional units embodying the principles of the described embodiments. Similarly, it will be appreciated that any flow charts and the like represent various processes which may be substantially represented in computer readable medium and so executed by a computer or processor, whether or not such computer or processor is explicitly shown. The functions of the various elements including functional blocks, may be provided through the use of hardware such as circuit hardware and/or hardware capable of executing software in the form of coded instructions stored on the above-mentioned computer readable medium. Thus, such functions and illustrated functional blocks are to be understood as being either hardware-implemented and/or computer-implemented, and thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and/or field programmable gate array(s) (FPGA(s)), and (where appropriate) state machines capable of performing such functions. In terms of computer implementation, a computer is generally understood to comprise one or more processors or one or more controllers. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method of operating a first electronic device for playback of streamed media at a user interface, the method comprising:
receiving, at the first electronic device, a first request requesting a first media content to be complemented with a second media content, the second media content being associated with the first media content;
in response to receiving the first request at the first electronic device, sending, to a second electronic device, a second request for the first media content to be complemented with the second media content;
receiving, at the first electronic device from the second electronic device, one or more media streams comprising the first media content and the second media content; and
playing, at the first electronic device, the first media content of the received one or more media streams complemented with and synchronized with the playing of the second media content of the received one or more media streams at the user interface.

2. The method of claim 1, wherein the first media content is synchronized with the second media content.

3. The method of claim 1, wherein receiving the media stream comprises:
receiving the media stream as a first media stream and a second media stream separately, wherein each of the first and second media streams comprises respective markers, and wherein playing the first media content and the second media content comprises synchronizing the received first media content and the received second media content according to the markers.

4. The method of claim 1, wherein the first media content comprises audio content and the second media content comprises textual content, and wherein playing the first media content and the second media content comprises playing the first media content at the user interface and displaying the second media content on the user interface.

5. The method of claim 4, wherein the audio content comprises a song and the textual content comprises lyrics.

6. The method of claim 1, wherein the first media content comprises audio content and the second media content comprises at least one of: image content and video content.

7. The method of claim 1, wherein the first media content comprises video content and the second media content comprises textual content, and wherein playing the first media content and the second media content comprises displaying the first media content on the user interface and displaying the second media content on the user interface, such that the second media content at least partly overlaps the first media content.

8. The method of claim 1, further comprising:
receiving a third request for control of playback; and
controlling playing in accordance with the received third request.

9. The method of claim 8, wherein the third request for control of playback relates to at least one of: fast-forwarding, rewind, jump, skip, next, and search.

10. A first electronic device for playback of a streamed media at a user interface, the first electronic device comprising:
a user interface;
a processor; and
a memory storing computer program code, which, when run in the processor causes the first electronic device to:
receive a first request requesting a first media content to be complemented with a second media content, the second media content being associated with the first media content,
in response to receiving the first request at the first electronic device, send, to a second electronic device, a second request for the first media content to be complemented with the second media content,
receive, at the first electronic device from the second electronic device, one or more media streams comprising the first media content and the second media content, and
play, at the first electronic device, the first media content of the received one or more media streams complemented with and synchronized with the playing of the second media content of the received one or more media streams at the user interface.

11. The first electronic device of claim 10, wherein the processor is adapted to receive the first media content synchronized with the second media content.

12. The first electronic device of claim 10, wherein the processor is adapted to receive the media stream as a first media stream and a second media stream separately, wherein each of the first and the second media streams comprises respective markers, and further adapted to synchronize the received first media content and the second media content according to the markers when playing the first media content and the second media content.

13. The first electronic device of claim 10, wherein the first media content comprises audio content and the second media content comprises textual content, and wherein the memory stores computer program code, which, when run in the processor causes the first electronic device to play the first media content and the second media content by playing the first media content at the user interface and displaying the second media content on the user interface.

14. The first electronic device of claim 13, wherein the audio content comprises a song and the textual content is lyrics.

15. The first electronic device of claim 10, wherein the first media content comprises audio content and the second media content comprises at least one of: image content and video content.

16. The first electronic device of claim 10, wherein the first media content comprises video content and the second media content comprises textual content, and wherein the memory stores computer program code, which, when run in the processor causes the first electronic device to play the first media content and the second media content by displaying the first media content at the user interface and displaying the second media content on the user interface, such that the second media content at least partly overlaps the first media content.

17. The first electronic device of claim 10, wherein the controller is adapted to receive a third request for control of playback, and further adapted to control playing in accordance with the received third request.

18. The first electronic device of claim 17, wherein the third request relates to at least one of: fast-forwarding, rewind, jump, skip, next.

19. A first electronic device for playback of a streamed media at a user interface, the first electronic device comprising:
a user interface;
a processor; and
a memory storing computer program code, which, when run in the processor causes the first electronic device to:
receive a first request requesting a first media content to be complemented with a second media content, the second media content being associated with the first media content,
in response to receiving the first request at the first electronic device, send, to a second electronic device, a second request for the first media content complemented with the second media content, the second electronic device comprising a media server,
receive, at the first electronic device from the second electronic device, a combined media stream comprising the first media content and the second media content, the first media content being synchronized with the second media content within the combined media stream, and
play, at the first electronic device, the first media content of the received combined media stream complemented and synchronized with the playing of the second media content of the received combined media stream at the user interface of the first electronic device.

20. The first electronic device of claim 19, the memory storing computer program code, which, when run in the processor causes the first electronic device to further:
alter the play the first media content of the received media stream complemented with the second media content of the received media stream at the user interface of the first electronic device, the altering comprising distinguishing a current portion of the second media content, the current portion of the second media content associated with a current portion of the first media content.
